(19) United States
(12) Patent Application Publication
(10) Pub. No.: US 2002/0198790 A1
(43) Pub. Date: Dec. 26, 2002

(54) Method and system for ordering goods or services

(76) Inventors: Daniel Leonard Paulo, Keller, TX (US); Bohdan Myron Pyskir, Naperville, IL (US); Matthew Richard Piette, Reston, VA (US); David Dombrowski, Carol Stream, IL (US)

Correspondence Address: MOTOROLA INC, 600 NORTH US HIGHWAY 45, LIBERTYVILLE, IL, 60048-5343, US

(21) Appl. No.: 09/891,696

(22) Filed: Jun. 26, 2001

(51) Int. Cl. G06F 17/60

(52) U.S. Cl. 705/26

(57) ABSTRACT

A system and method of ordering goods or services including receiving a request for the goods or services from a user by way of a device and accessing a database having information relevant to the user and preferences, such as favorites, related to the goods or services. Then forwarding an order for the goods or services to a provider, either a store as selected or a central server for selection of a store, of the goods or services where the order is dependent on the information and receiving a reply such as an acknowledgment regarding the order from the provider. Then formulating a response concerning the order and the reply, the response preferably dependent on capabilities of the device; and sending the response to the device using instant messaging, short messaging services or WAP messaging techniques.

### FIELD OF THE INVENTION

This invention concerns methods of ordering goods or services and more specifically systems and methods relying on e-commerce techniques for doing so.

### BACKGROUND OF THE INVENTION

Rudimentary systems for the online ordering of goods are known. One system is described is U.S. Pat. No. 5,991,739 titled INTERNET ONLINE ORDER METHOD AND APPARATUS Cupps et al. In this reference, orders for restaurants are accepted from a client computer coupled via the Internet to an order engine that in turn connects to the user selected vendor by voice driven telephone connections. The user or device interface is fixed, the vendor or store is selected by the user, and the selections available are controlled by the relative latitude and longitude associated with the user delivery location and store location. No provisions exist for communicating from the order engine to a provider server or intermediate server rather than directly with the vendor or store. Clearly a need exists for a system and method for ordering goods or services that provides an interface that is adapted to the user device capabilities and facilitates ordering goods or services given those capabilities and allows store selections based on various location parameters and business distribution parameters by either the ordering engine or an intermediate provider server.

### BRIEF DESCRIPTION OF THE DRAWINGS

The accompanying figures, where like reference numerals refer to identical or functionally-similar elements throughout the separate views and which are incorporated in and form part of the specification, further illustrate various embodiments in accordance with the present invention. The figures together with the detailed description, hereinafter below, serve to explain various principles and advantages in accordance with the present invention.

FIG. 1 depicts, in a simplified and representative form, a system for ordering goods or services in accordance with the present invention; and

FIG. 2 depicts, in a simplified and representative form, a flow chart for a method of ordering goods or services suitable for use in the system of FIG. 1 in accordance with the present invention.

### DETAILED DESCRIPTION OF A PREFERRED EMBODIMENT

As an overview, the present disclosure concerns methodologies and systems for ordering goods and services and more specifically such methods and systems especially adapted to facilitate the ordering process in view of the practicalities and capabilities of devices employed by users and the typical organization and operation of various goods and services enterprises and providers. By way of example and not limitation, such providers and enterprises include various food providers or vendors that specialize in or are adapted to serve either carryout or delivery customers or clients. Certain of the inventive principles and combinations or equivalents disclosed herein may be especially advantageous where such goods or services are subject to repeat orders. Other principals, combinations, or equivalents will have applicability to virtually any situation where goods or services may be ordered. The present disclosure will focus on a preferred system for ordering pizza but those of modest skill will recognize the applicability of the inventive principles to systems for ordering other goods or services. As further discussed below various inventive principles and combinations thereof are advantageously employed to provide user convenience and comfort in the everyday task of ordering goods or services provided these principles or equivalents are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use, if any, of relational terms such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

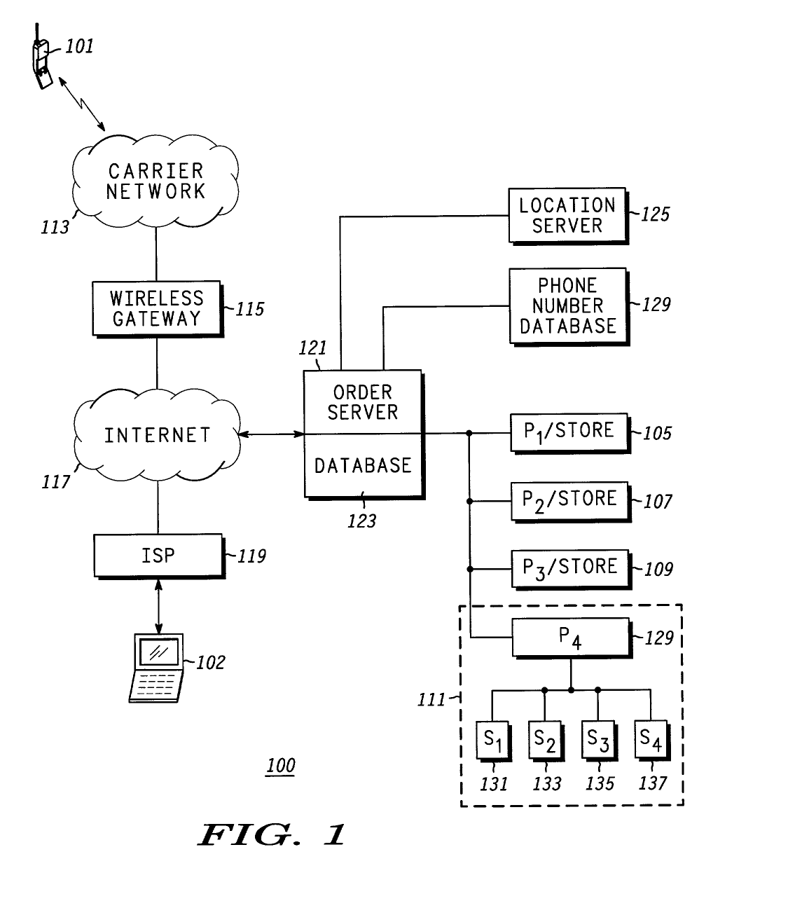

The present disclosure will discuss various embodiments in accordance with the invention. These embodiments include methods, systems, and constituent elements thereof employing each or all of the aforesaid principals. The system diagram of FIG. 1 will be used to lay the groundwork for a deeper understanding of the present invention and advantages thereof. FIG. 1 in large part and at the simplified level depicted is a representative diagram of a system 100, suitable for ordering goods or services for example, a pizza or ethnic or other takeout or delivery based fast food ordering system, and will serve to explain the problems and certain inventive solutions thereto according to the present invention.

The system of FIG. 1 in a sense couples users by way of user devices 101, 102 to providers 105, 107, 109, 111 of goods or services and vice a versa. This is done in a manner that is adaptable to their respective circumstances in order to be efficient and easy for the users and providers. Device 101, a mobile device, preferably a cellular or PCS handset that is web enabled or a wireless PDA using a Palm or CE operating system, is wirelessly coupled by way of the carrier network 113 to a wireless gateway 115, such as a Wireless Access Protocol (WAP) gateway or xHTML gateway or the like, and thus to the internet or world wide web 117 as generally known. The carrier network 113 is typically a wide area network such as cellular or PCS mobile phone system but may also be a local area network serving a smaller area such as a home, office, business, airport, shopping mall, or a like area. Generally, device 101 will be characterized by a limited capability operator interface such as a small display and keyboard or the like. Device 102, preferably a stand alone personal computer or an interactive television or the like, is coupled by a wired or wireless link to an internet service provider (ISP) 119 and thus to the internet 117 again by known techniques. Device 102 may have a much more capable operator interface including a larger display, etc.

The internet 117 couples the respective devices to the order server 121 which acts by way of a database 123 as a repository for data regarding the respective users or devices, a clearinghouse for orders, and a facilitator between the devices or users and providers of the goods and services. The order server 121 is a known general purpose computer or server system such as those available from Sun Microsystems, HP, IBM, etc that is performing software instructions sufficient to accomplish the herein disclosed principles and operations as well as those necessarily implied by virtue of the system of FIG. 1. The order server 121 is further coupled to a location server 125 and a phone number server 127. The location server 125 provides a translation between a user or device's present or current location, one or more addresses, or zip plus fours and location indicia relative to the various provider's locations. The phone number server 127 is used by the order server 121 typically during an initial order or registration procedure from a new user to allow a simple phone number to be cross referenced to a particular user thereby saving that user the effort required to enter a full name, address, or the like. This service is available from a company called White Pages for example. Note that while the connections to the providers 105-111 and servers 125, 127 are explicitly shown these connections are likely and preferably also through the Internet.

In overview form the system 100 in operation facilitates a method of ordering goods or services that after registration begins with receiving a request for the goods or services from a user by way of a device, such as a mobile device or personal computer or organizer and then accessing a database having information relevant to the user and preferences related to the goods or services. Note this operation will preferably vary in accordance with the type of or capability of the device. For example with mobile device 101, for example a cellular or other wireless handset or messaging device that is WAP enabled and has a limited display or keyboard, it will often be preferable that the order be received as a series of choices communicated by entering, responsive to prompts generated at the order server, a sequence of numbers. In this case, a series of indications for the order and accesses to the database would be required. For example “1” for delivery rather than “2” for carryout or pickup followed by a “3” for the 3^{rd} favorite rather than “1” for the 1^{st} favorite type of pizza and accoutrements where these favorites have been previously defined. If the device is a personal computer a few mouse clicks may be used and the order submitted in one exchange.

The next step is forwarding an order for the goods or services to a provider of the goods or services, here pizza, where the order is dependent on the information relevant to the user that has been retrieved from the database. Usually a store or recommended store is provided with each order. This store or recommended store will often be determined by the user based on available menu items shown or indicated at the time of the order being placed or at the time a favorite was defined and when this store is determined by the user it may be a selection made from a list as displayed or caused to be displayed by the order server. Note the order server 121 may select the appropriate provider or store to fill the order from amongst providers 105, 107, 109 based on user determination, load management, preferential business placement, location of the store relative to the users current location or delivery address or zip plus four or the like. On the other hand the order server may merely forward the order to an intermediate or central server 129 for the provider and that server may select the store to fill the order from amongst its franchisees or member stores 131-137 based on its own algorithms considering user preferences, load management, preferential business placement, relative locations and so on.

This notion of selecting or determining a store will benefit from some more discussion. Very often as above noted a user when defining an order or a favorite will choose a store. Ordinarily this choice will be from a list proposed by the order server based on relative locations, user preferences, etc. Sometimes that choice will dictate the store that is ultimately selected to fill the order due, for example, to some particular menu item that is not available at any other provider or store. However, in many cases multiple stores, if not providers, will be able to fill a particular order. In this instance, the order server 121 will be able to select or at least propose for the users review various stores in the form of a suggested list or a prioritized list. If the user has not determined or chosen a particular store or if the user has only picked a particular provider, such as Domino's, then the order server or alternatively a central server for the provider has complete liberty to select the store where the order will be placed or filled. Additionally, even where the user has made a recommendation or determination the order server is free to suggest alternatives to the user. These alternatives as well as those selected with complete liberty can be driven by economic considerations on the part of the server or user. For example, suppose the user has selected or indicated store 1 for a favorite order but the order server notices that store 2 is offering the same or similar thing at a cheaper price. Or perhaps store 2 is willing to pay the order server a larger fee for business than store 1 or perhaps the delay in filling an order is much longer at the originally indicated store than some alternative store. In each case it is likely appropriate for a different store to be selected to fill the order in some cases with the customer or user complicity and in some cases without. Note also the timing associated with the determination of a store. Where the customer or user makes this determination or selection or proposed selection it is normally done at the time the order is input, or favorite is defined. However at the time the order is placed or an attempt is undertaken to place an actual order, a provider or store is actually selected. Until that time the store is recommended or suggested or determined or whatever. However normally when a customer or user determines or selects a store, that store is the one that will be selected by the order server or central server as the store that will fill the order.

In any event, the next step is receiving at the order server 121 a reply regarding the order from the provider where the order was forwarded. This reply from the store or provider may acknowledge or accept the order and provide an expected time to completion or delivery and amount of money due and so on or may reject the order. In the latter case the order server 121 can select another or next best store or provider and repeat the step of forwarding the order and receiving a reply. Note it may not be possible for the order server to find a next best provider or store given the particulars of or restrictions associated with the order.

At any rate the next step is formulating a response concerning the order and the reply, wherein preferably, the response is adapted to or dependent on the capabilities of the device, for example device display. Lastly, this response is sent to the relevant device. As alluded to above the process of receiving a request for goods and services may be a request for a favorite form of the goods or services. In this case the act of ordering a pizza and large coke may be as simple as pushing the key corresponding to pizza on a WAP enabled handset and pushing it again to signify the favorite form for this order. If there are several favorites then push the pizza key followed by a number key signifying which of a plurality of favorites. Thereafter the order server accesses a database that includes the requisite information regarding the favorite form or plurality of favorite forms of the goods and services for that respective user. This favorite information can include preferred method of payment and preferred provider or store address for delivery, etc. Various methodologies of sending the response or acknowledgement of the order are contemplated including for example sending the response or acknowledgment using a short messaging service, an internet relay chat (IRC), such as instant messaging service, or a wireless access protocol message. The one used will depend on the user's preferred method of acknowledgement as well as the capabilities of the user's device.

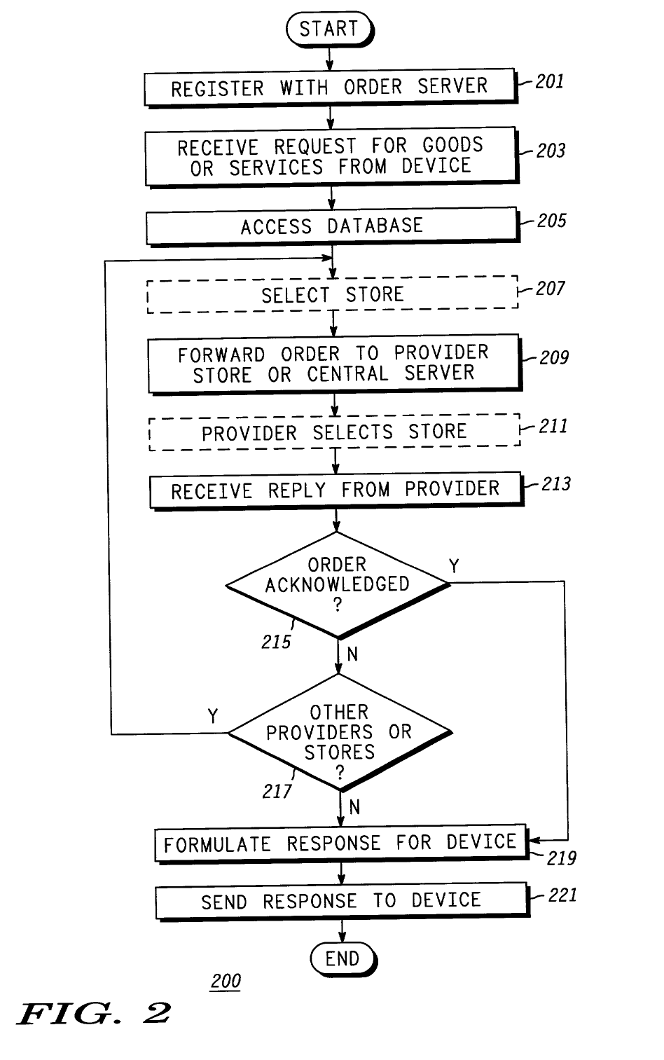

Referring to the flow chart of FIG. 2 various embodiments of a method 200 for ordering goods or services will be described. The method starts and at step 201 registration for a particular user is undertaken. Here various information regarding the user is entered into the database 123. User information including one or more delivery addresses, methods of payments, contact information, and acknowledgment and notification routing, are stored specific to each user. User's favorites may also be stored here. Each favorite combines specific pieces of the above information: delivery address, method of payment, contact information, special instructions, routing, and combines them with a particular set of menu items and the respective store or stores assigned to produce the goods or service. The user profile or information entered during registration or thereafter, for example information regarding favorites, will facilitate the user's later attempts to order goods or services. This will be particularly important when the user or customer is faced with utilizing a device such as device 101 with a very limited user interface.

Next at step 203 the process receives a request for the goods or services from a user by way of a device, such as a mobile device or personal computer. Here device 101 or 102 sends some indicia or indication or the desired goods or services such as an order for a pizza or at least sufficient substance to infer such an order. Step 205 shows accessing a database having information relevant to the user and preferences or user profile information related to the goods or services. As above noted steps 203 and 205 can be iterative and the request will likely be in a form adapted to the capabilities of the particular device. For example, the request will be very abbreviated when the user merely wants to order his favorite form of pizza. The relevant information for the favorite form will be obtained from the database together for example with the location for delivery and desired method of payment. The user has the ability to change specifics of this information using processes dependent upon which user device he happens to be using to access the service. The user's ordering history is also stored, and his last order is offered as a quick menu item to facilitate another easy reorder. Note that a last order and a favorite order are unique concepts however if a user's last order may also have been a favorite order

Next at optional step 207 a store is selected. This represents the situation where the order server 121 is given the task of selecting a proper store. For example if the user favorites does not require a particular store and the provider has not taken this responsibility by way of a central server the order server 121 will have the task. In many instances, it is expected that the store selection will occur prior to receiving the actual indication of an order. For example if the selection criteria for choosing a store is based only on relative location the store can be pre-selected thus eliminating any delay at the time of the order. The order server as above noted can select a store based on the customer's address, or present location, or zip plus four information, or perhaps a favorite form of the goods and services. The order server checks to ensure the favorite is still valid by checking against the current menu for the respective store. Alternatively or additionally, the order server may select the store based on load management, expected delays in obtaining the goods or services, or preferential business placement. When business rules are available to allow for load balancing, based on data received from the provider systems, the central order server applies the rules, then checks the designated store's menu to ensure it is capable of handling the order. Appropriate rules may include not placing orders with stores where the queue, latency, or wait exceeds 20 minutes or where other things being equal another store has a shorter wait. Stores paying more for the order server based service may receive preferential treatment with orders or stores where customer feedback is more favorable may receive preferential treatment.

At step 209, the process forwards an order for the goods or services to a provider, for example the selected store or a central server for a provider, of the goods or services, where the order in one or more ways is dependent on the information obtained form the database. The order will include the specifications for the desired goods or services, such as pizza size, toppings, etc and any additional food items such as drinks, condiments, etc as well as whether the order is for delivery or pickup, desired time if any, contact information if required etc. Then at optional step 211 if the order was forwarded to a central server for a provider this server will need to select a store to fill the order and forward the order to that store.

In any event, step 213 shows receiving a reply including any particulars regarding the order from the provider where the order was sent. At step 215, this reply is tested to see if the order has been acknowledged. If not, step 217 tests whether there are other possible providers and if so the process loops back to step 207. If the order has been acknowledged or if there are no other possible providers, the process moves to step 219. At step 219 a response concerning the order and the reply including any particulars such as expected time of delivery or availability is formulated. This response is preferably dependent on or adapted to capabilities of the device. Then at step 221 the response is sent to the device and the process ends. Note the particular response is likely to be an acknowledgment of the order and the step of sending this response will include sending the acknowledgment using one of a short messaging service, an instant message, and a wireless access protocol message. The method of delivery of the acknowledgement, as well as notification of any errors or issues with the order, is chosen by the user. At registration, the user provides at least an email address to use as the default method of notification. The user may also provide addressing which will be used to enable the delivery of the notification via pager, SMS, other cell phone alert, IRC, or other methods. The user specifies which method to use with each favorite or order and may change the target notification device at any time during the order process.

Store selection can be determined using one or more or combinations of various factors. For pick-up or carry-out orders the user can choose the store from a list provided him or allow the order server or provider to choose the store from the list. The list is based on information gathered from the user (ZIP code or address), or from the live data session (for cell phone sessions, the user's actual location can be determined and delivered without any action by the user). For delivery orders, the delivery address must be determined. It can be taken from the user's profile or favorites information or, if changed, submitted by the user. A store look-up is then performed to determine which store's delivery zone handles that particular address. The look-up is performed by using n a ZIP plus four based geocoding method which creates delivery polygons around each store. The system determines which, if any, of the delivery polygons contain the respective ZIP plus four or specifically delivery address associated therewith. Once the store is determined, that respective store's menu is provided to the user.

For large vendor chains, the load-balancing feature can be used. When an order is received for a particular store, the store's current queue of orders is accessed via the local POS and if it is above a specified or predetermined level, for example 30 minutes for a pick up order or beyond the desired time if specified, the queues from other stores that may be suitable for filling the order are examined to determine whether any of these stores can handle this order. If the other stores are capable of handling this order, namely there respective queues are proper, the order is submitted to that store, if not, it is returned to the original store and the user's device is notified of expected time of delivery.

The system is also capable of preferential order delivery. In use, this feature allows the system to check orders against a list of preferred stores. If any of these are capable of handling the order, the order may be directed to the preferred store.

Various embodiments of systems and methods for ordering goods and services, preferably fast foods such as pizza have been explained and described. In particular these systems and methods are arranged and constructed to be adaptable to and take into consideration human factors resulting from devices having varying levels of interface capability. The methods and systems have shown various criteria for selecting a provider of the goods and services as well as especially efficient techniques for ordering favorites or favorite forms of the goods or services. This is particularly advantageous for repeat orders. Also described were alternative methodologies for forwarding orders to a sole store versus a central server associated with numerous stores as well as various ways of acknowledging or replying to a user or customer regarding their order. The disclosure extends to the constituent elements or equipment comprising such systems and the methods employed thereby and therein. This disclosure is intended to explain how to fashion and use various embodiments in accordance with the invention rather than to limit the true and intended scope and spirit thereof. The invention is intended to be defined solely by the appended claims, as may be amended during the pendency of this application for patent, and all equivalents thereof.

What is claimed is:

1. A method of ordering goods or services including the steps of:
receiving a request for the goods or services from a user by way of a device;
accessing a database having information relevant to said user and preferences related to said goods or services;
forwarding an order for the goods or services to a provider of said goods or services, said order dependent on said information;
receiving a reply regarding said order from said provider;
formulating a response concerning said order and said reply, said response dependent on capabilities of said device; and
sending said response to said device.

2. The method of claim 1 wherein said step of receiving a request includes receiving said request from a mobile device.

3. The method of claim 1 wherein said step of receiving a request further includes receiving a request for a favorite form of said goods and services and wherein said step of accessing a database further includes accessing a database including information regarding said favorite form of said goods and services.

4. The method of claim 1 wherein said step of forwarding said order further includes forwarding said order to a central server for said provider.

5. The method of claim 4 further including a step of selecting, at said central server, a store at said provider to fill said order.

6. The method of claim 5 wherein said step of selecting said store includes selecting said store based on one of an address associated with said user, a current location of said device, a ZIP code plus four associated with said user, and a favorite form of the goods or services.

7. The method of claim 5 wherein said step of selecting said store includes selecting said store based on one of load management and preferential business placement.

8. The method of claim 1 further including a step of selecting a store corresponding to said provider to fill said order.

9. The method of claim 8 wherein said step of selecting said store includes selecting said store based on one of an address associated with said user, a current location of said device, a ZIP code plus four associated with said user, and a favorite form of the goods or services.

10. The method of claim 8 wherein said step of selecting said store includes selecting said store based on one of load management and preferential business placement.

11. The method of claim 1 wherein said step of receiving a request further includes receiving a request that is dependent on said capabilities of said device.

12. A method of ordering goods or services including the steps of:
receiving a request for the goods or services from a user by way of a device;
accessing a database having information relevant to said user and a favorite form of said goods or services;
forwarding an order for said favorite form of the goods or services to a provider of said goods or services;
receiving a reply regarding said order from said provider;
formulating a response concerning said order and said reply; and
sending said response to said device.

13. The method of claim 12 wherein said step of receiving a request includes receiving said request from a mobile device.

14. The method of claim 12 wherein said step of receiving a request further includes receiving a request that is dependent on capabilities of the device.

15. The method of claim 12 wherein said step of forwarding said order further includes forwarding said order to a central server for said provider.

16. The method of claim 15 further including a step of selecting, at said central server, a store associated with said provider to fill said order.

17. The method of claim 16 wherein said step of selecting said store includes selecting said store based on one of an address associated with said user, a current location of said device, a ZIP code plus four associated with said user, and said favorite form of the goods or services.

18. The method of claim 16 wherein said step of selecting said store includes selecting said store based on one of load management and preferential business placement.

19. The method of claim 12 further including a step of selecting a store corresponding to said provider to fill said order.

20. The method of claim 19 wherein said step of selecting said store includes selecting said store based on one of an address associated with said user, a current location of said device, a ZIP code plus four associated with said user, and said favorite form of the goods or services.

21. The method of claim 19 wherein said step of selecting said store includes selecting said store based on one of load management and preferential business placement.

22. The method of claim 12 wherein said step of receiving a request further includes receiving a request for said favorite form of the goods and services, said favorite form having been selected from among a plurality of favorite forms by said user.

23. The method of claim 22 further including a step of storing information for said plurality of favorite forms in said database.

24. A method of ordering goods or services including the steps of:
receiving a request for the goods or services from a user by way of a device;
accessing a database having information relevant to said user and preferences related to said goods or services;
forwarding an order for the goods or services to a central server for a provider of said goods or services, said order dependent on said information;
receiving a reply regarding said order from said provider;
formulating a response concerning said order and said reply; and
sending said response to said device.

25. The method of claim 24 wherein said step of receiving a request includes receiving said request from a mobile device that is web enabled.

26. The method of claim 24 wherein said step of receiving a request further includes receiving a request for a favorite form of said goods and services and wherein said step of accessing a database further includes accessing a database including information regarding said favorite form of said goods or services.

27. The method of claim 24 further including a step of selecting, at said central server, a store from a plurality of stores associated with said provider to fill said order.

28. The method of claim 27 wherein said step of selecting said store includes selecting said store based on one of an address associated with said user, a current location of said device, a ZIP code plus four associated with said user, and a favorite form of the goods or services.

29. The method of claim 27 wherein said step of selecting said store includes selecting said store based on one of load management and preferential business placement.

30. The method of claim 24 further including a step of selecting a store associated with said provider to fill said order and forwarding information indicative of said store to said central server.

31. The method of claim 30 wherein said step of selecting said store includes selecting said store based on one of an address associated with said user, a current location of said device, a ZIP code plus four associated with said user, and a favorite form of the goods or services.

32. The method of claim 30 wherein said step of selecting said store includes selecting said store based on one of load management and preferential business placement.

33. The method of claim 24 wherein said step of receiving a request further includes receiving a request that is dependent on capabilities of said device and said step of formulating said response includes formulating a response that is dependent of said capabilities of said device.

34. The method of claim 24 wherein said step of formulating a response includes formulating an acknowledgment of said order and said step of sending said response includes sending said acknowledgment using one of a short messaging service, an instant message, and a wireless access protocol message.

35. A method of ordering goods or services including the steps of:
receiving a request for the goods or services from a user by way of a device;
accessing a database having information relevant to said user and preferences related to said goods or services;
selecting a store associated with a provider of said goods or services;
forwarding an order for the goods or services to said store, said order dependent on said information;
receiving a reply regarding said order from said store;
formulating a response concerning said order and said reply; and
sending said response to said device.

36. The method of claim 35 wherein said step of receiving a request includes receiving said request from a mobile device that is web enabled.

37. The method of claim 35 wherein said step of receiving a request further includes receiving a request for a favorite form of said goods and services and wherein said step of accessing a database further includes accessing a database including information regarding said favorite form of said goods and services.

38. The method of claim 35 wherein said step of selecting said store includes selecting said store based on one of an address associated with said user, a current location of said device, a ZIP code plus four associated with said user, and a favorite form of the goods or services.

39. The method of claim 35 wherein said step of selecting said store includes selecting said store based on one of load management and preferential business placement.

40. The method of claim 35 further including a step of forwarding information indicative of said store to said device.

41. The method of claim 35 wherein said step of receiving a request further includes receiving a request that is dependent on capabilities of said device and said step of formulating said response includes formulating a response that is dependent of said capabilities of said device.

42. The method of claim 35 wherein said step of formulating a response includes formulating an acknowledgment of said order and said step of sending said response includes sending said acknowledgment using one of a short messaging service, an instant message, and a wireless access protocol message.
